(19) United States
(12) Patent Application Publication
(10) Pub. No.: US 2019/0210212 A1
(43) Pub. Date: Jul. 11, 2019

(54) Work Table Assembly

(71) Applicants: Carmelo Ramirez, Granite City, IL (US); Patricia Ramirez, Granite City, IL (US)

(72) Inventors: Carmelo Ramirez, Granite City, IL (US); Patricia Ramirez, Granite City, IL (US)

(21) Appl. No.: 15/866,566

(22) Filed: Jan. 10, 2018

(51) Int. Cl. B25H 1/02; B25H 1/00; B25H 1/14; B25H 7/02

(52) U.S. Cl. CPC B25H 1/02; B25H 7/02; B25H 1/14; B25H 1/0035

(57) ABSTRACT

A work table assembly includes a table that may be positioned on a support surface. An object, such as lumber or the like, is selectively positioned on the table for cutting and otherwise manipulating. A plurality of extension units is provided and each of the extension units is slidably coupled to the table. Each of the extension units is selectively positioned in a deployed position to support an object that is larger than the table. Each of the extension units is selectively positioned in a stored position. A plurality of panels is provided and each of the panels is selectively positioned on the table to define a horizontal support surface.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to table devices and more particularly pertains to a new table device for supporting an object for cutting and otherwise manipulating.

### (h) BRIEF SUMMARY OF THE INVENTION

An embodiment of the disclosure meets the needs presented above by generally comprising a table that may be positioned on a support surface. An object, such as lumber or the like, is selectively positioned on the table for cutting and otherwise manipulating. A plurality of extension units is provided and each of the extension units is slidably coupled to the table. Each of the extension units is selectively positioned in a deployed position to support an object that is larger than the table. Each of the extension units is selectively positioned in a stored position. A plurality of panels is provided and each of the panels is selectively positioned on the table to define a horizontal support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a work table assembly according to an embodiment of the disclosure.

FIG. 2 is a top view of an embodiment of the disclosure.

FIG. 3 is a front view of an embodiment of the disclosure.

FIG. 4 is a right side view of an embodiment of the disclosure.

FIG. 5 is an exploded perspective view of an embodiment of the disclosure.

FIG. 6 is a perspective view of a square and a clamp of an embodiment of the disclosure.

### (j) DETAILED DESCRIPTION OF THE INVENTION

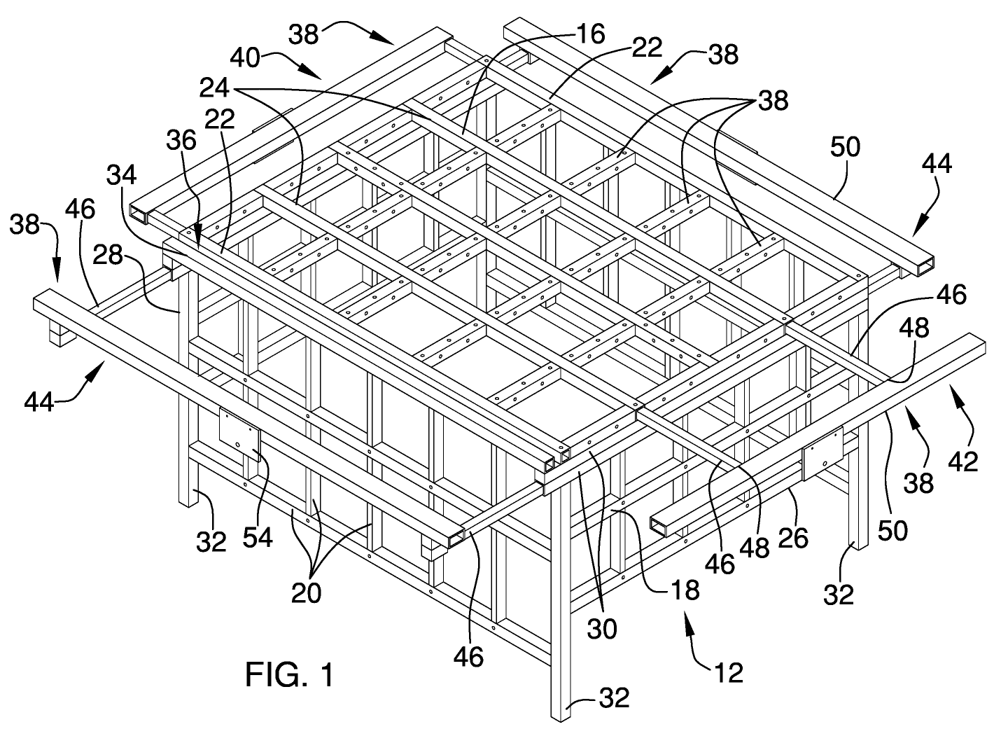

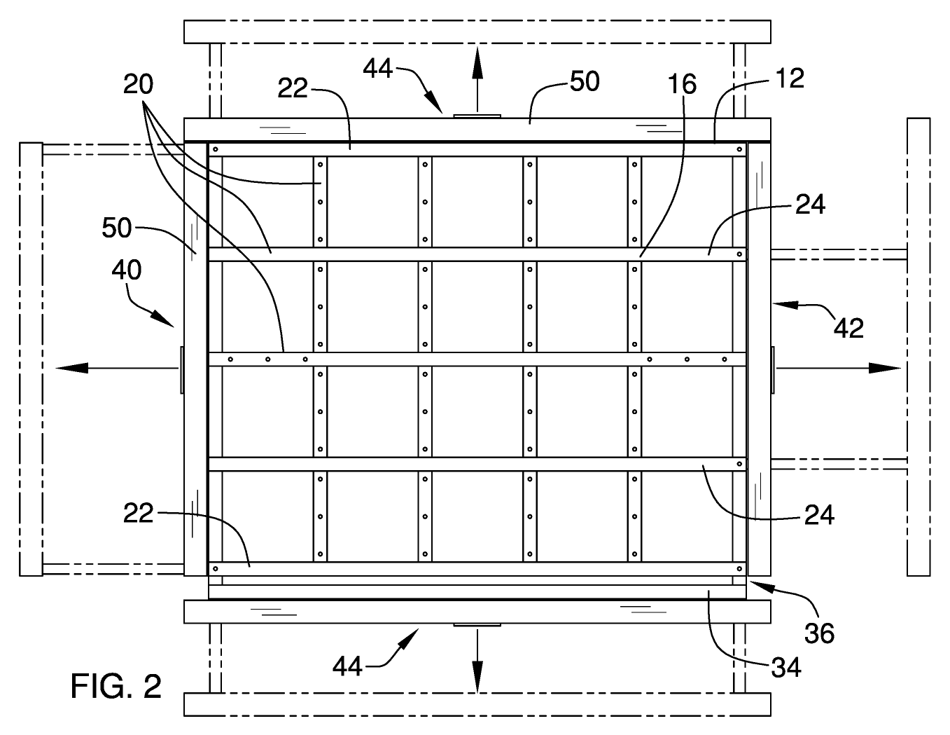

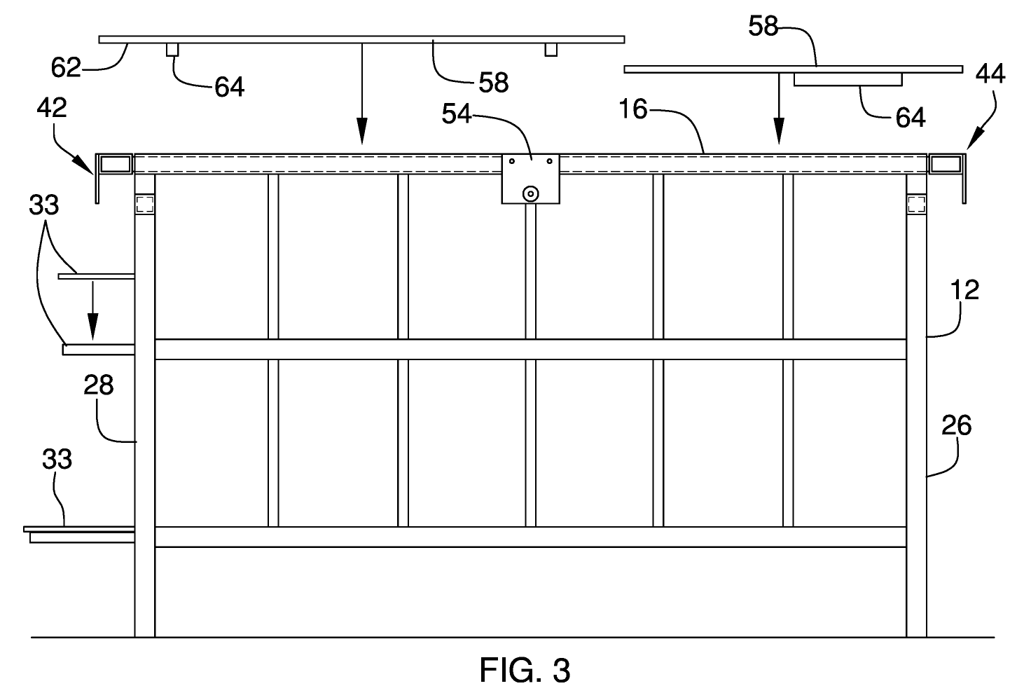

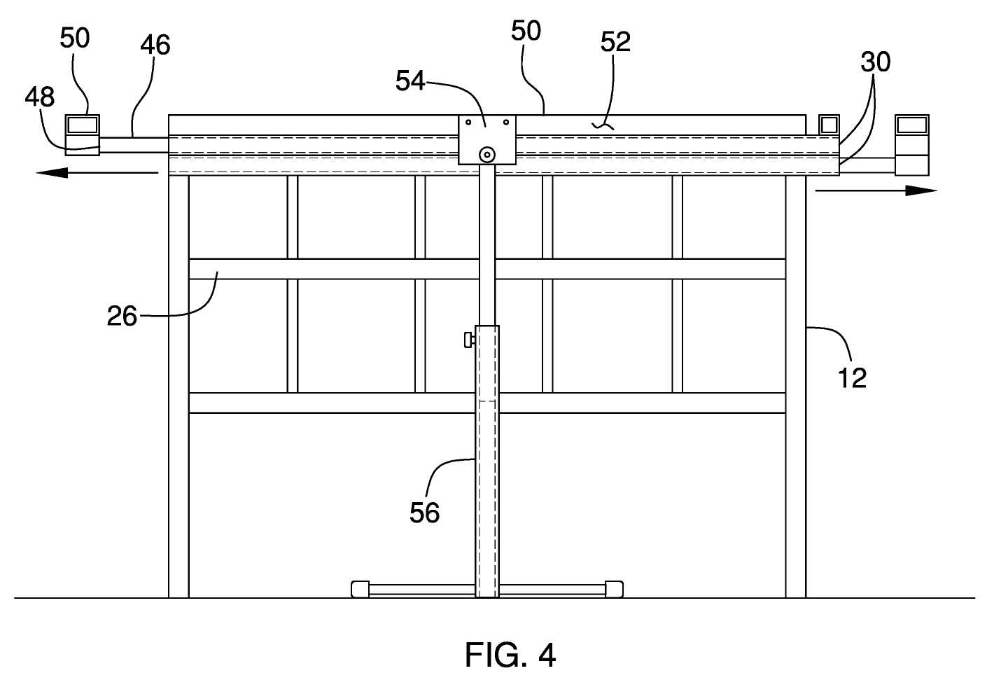

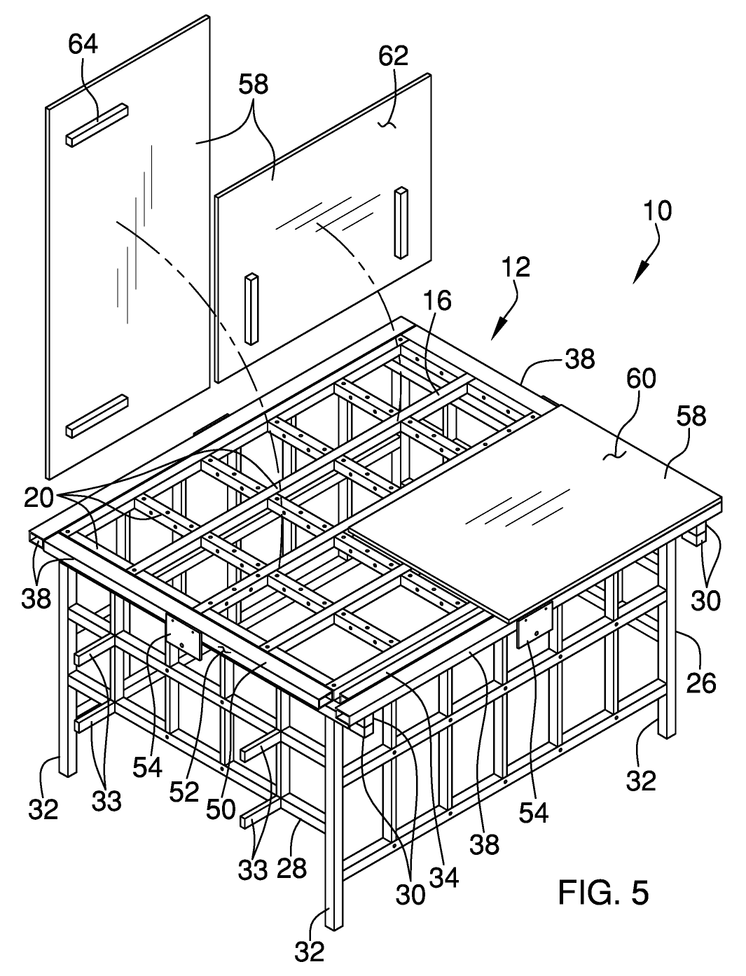

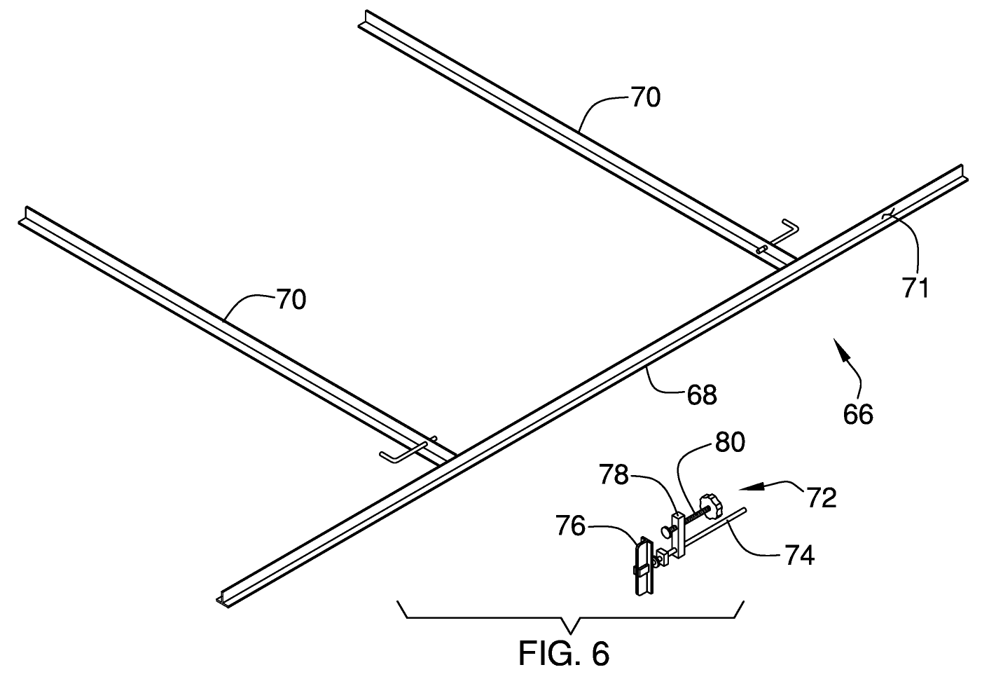

With reference now to the drawings, and in particular to FIGS. 1 through 6 thereof, a new table device embodying the principles and concepts of an embodiment of the disclosure and generally designated by the reference numeral 10 will be described.

As best illustrated in FIGS. 1 through 6, the work table assembly 10 generally comprises a table 12 is configured to be positioned on a support surface 14. An object, such as a panel of plywood, a length of lumber and any other object, is selectively positioned on the table 12 for cutting and otherwise manipulating. The table 12 has a top side 16 and a perimeter side 18 extending downwardly therefrom. Each of the top side 16 and the perimeter side 18 comprise a plurality of intersecting members 20 to define a grid.

The members 20 corresponding to the top side 16 includes a pair of outward members 22 and a pair of medial members 24. Each of the outward 22 and medial 24 members is substantially hollow and has a pair of open ends. The perimeter side 18 has a first side 26 and a second side 28 and the members corresponding to each of the first 26 and second 28 side includes a pair of topmost members 30. Each of the topmost members 30 is substantially hollow and has a pair of open ends. The perimeter side 18 has a plurality of legs 32 extending downwardly therefrom to abut the support surface 14. A plurality of shelves 33 may each be removably coupled to the perimeter side 18 of the table 12 for supporting tools and the like. The plurality of shelves 33 may be vertically distributed on the perimeter side 18.

The members corresponding to the top side 16 includes a guide member 34. The guide member 34 is spaced from an associated one of the outward members 22 to define a cutting space 36 between the guide member 34 and the outward member. The cutting space 36 receives a blade of a saw thereby facilitating the saw to be urged along an entire length of the table 12 without engaging the table 12. The saw may be an electric circular saw or the like.

A plurality of extension units 38 is provided and each of the extension units 38 is slidably coupled to the table 12. Each of the extension units 38 is selectively positioned in a deployed position to support an object that is larger than the table 12. Each of the extension units 38 is selectively positioned in a stored position. The plurality of extension units 38 includes a first extension unit 40, a second extension unit 42 and a pair of third extension units 44.

Each of the plurality of extension units 38 comprises a pair of first bars 46 that each has a first end 48. Each of first bars 46 corresponding to the first extension unit 40 is slidably positioned in an associated one of the outward members 22 having the first bars 46 extending laterally away from the table 12. Each of the first bars 46 corresponding to the second extension unit 42 is slidably positioned in an associated one of the medial members 24 having the first bars 46 extending laterally away from the table 12. The first extension unit 40 is positioned on an opposite side of the table 12 with respect to the second extension unit 42. Each of the first bars 46 corresponding to the pair of third extension units 44 is slidably positioned in an associated one of the topmost members 30. Moreover, the third extension units 44 are positioned on opposite sides of the table 12 with respect to each other.

A second bar 50 is coupled between the pair of first bars 46 and the second bar 50 is aligned with the first end 48 of the first bars 46. The second bar 50 corresponding to each of the extension units 38 is spaced from the table 12 when the extension units 38 are positioned in the deployed position. In this way the second bar 50 supports the object that is larger than the table 12, such as a full sheet of plywood or the like. The second bar 50 corresponding to each of the extension units 38 abuts the table 12 when the extension units 38 are positioned in the stored position. The second bar 50 has an outwardly facing surface 52 with respect to the table 12 and the second bar 50 is oriented to be level with the top side 16 of the table 12.

A plate 54 is coupled to the outwardly facing surface 52 corresponding to each of the extension units 38. The plate 54 extends downwardly from the outwardly facing surface 52. A support leg 56, such as a saw horse or any other mechanical support, is selectively coupled to the plate 54 to support the first 40 and second 42 extension units. The plate 54 corresponding to each of the extension units 38 may have mounting holes therein for engaging the saw horse or other mechanical support.

A plurality of panels 58 is provided and each of the panels 58 is selectively positioned on the table 12 to define a horizontal support surface 60. Each of the panels 58 has a first surface 62 and the first surface 62 lies on the members corresponding to the top side 16 when the panels 58 are positioned on the table 12. The first surface 62 of each of the panels 58 has a tab 64 extending downwardly therefrom. Moreover, the tab 64 on each of the panels 58 engages an associated one of the members corresponding to the top side 16 to inhibit the panels 58 from sliding off of the table 12.

A square 66 is provided that has a central member 68 extending between a pair of outside members 70. The central member 68 has a vertical surface 71 and each of the outside members 70 is selectively coupled to the table 12, via a clamp or the like. In this way the vertical surface 71 provides a straight edge for cutting and measuring. A clamp 72 is provided to attach the object to the square 66 for marking and cutting. The clamp 72 includes a first rod 74, a base 76, a slide 78 and a second rod 80. The first rod 74 is coupled to and extends away from the base 76 and the slide 78 is slidably positioned on the first rod 74. The slide 78 frictionally engages the first rod 74 to releasably retain the slide 78 at a selected point along the first rod 74. The second rod 80 extends through and threadably engages the slide 78 that the second rod 80 selectively compresses the object between the second rod 80 and the base 76.

In use, the table 12 is positioned on the support surface 14 for cutting and marking elongated lumber, panels of plywood and any other material. Each of the extension units 38 is selectively deployed to support the object that is larger than the table 12. In this way the object that is larger than the table 12 is facilitated to be safely cut. The support leg is selectively coupled to the plate 54 on the first 40 and second 42 extension units when the first 40 and second 42 extension units are in the deployed position. Each of the outside members 70 of the square 66 is selectively coupled to the table 12 thereby orienting the vertical surface as a straight edge. Additionally, the central member 68 of the square 66 may be oriented parallel to the cutting space 36. In this way the object may be cut in a straight line. Each of the panels 58 is selectively positioned on the table 12 thereby facilitating the panels 58 to define the horizontal support surface 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. A work table assembly having a plurality of extendable supports wherein said assembly is configured to support an object for cutting, said assembly comprising:
a table being configured to be positioned on a support surface, said table being configured to have an object positioned thereon for cutting;
a plurality of extension units, each of said extension units being slidably coupled to said table, each of said extension units being selectively positioned in a deployed position wherein each of said extension units is configured to support an object that is larger than said table, each of said extension units being selectively positioned in a stored position;
a plurality of panels, each of said panels being selectively positioned on said table to define a horizontal support surface; and
wherein said table has a top side and a perimeter side extending downwardly therefrom, each of said top side and said perimeter side comprising a plurality of intersecting members to define a grid.

3. The assembly according to claim 2, wherein said members corresponding to said top side includes a pair of outward members and a pair of medial members, each of said outward and medial members being substantially hollow and having a pair of open ends.

4. The assembly according to claim 2, wherein said perimeter side has a first side and a second side, said members corresponding to each of said first and second side including a pair of topmost members, each of said topmost members being substantially hollow and having a pair of open ends, said perimeter side having a plurality of legs extending downwardly therefrom wherein each of said legs is configured to abut the support surface.

5. The assembly according to claim 3, wherein said members corresponding to said top side includes a guide member, said guide member being spaced from an associated one of said outward members to define a cutting space between said guide member and said outward member wherein said cutting spaced is configured to receive a blade of the saw thereby facilitating the saw to be urged along an entire length of said table without engaging said table.

6. A work table assembly having a plurality of extendable supports wherein said assembly is configured to support an object for cutting, said assembly comprising:
a table being configured to be positioned on a support surface, said table being configured to have an object positioned thereon for cutting;
a plurality of extension units, each of said extension units being slidably coupled to said table, each of said extension units being selectively positioned in a deployed position wherein each of said extension units is configured to support an object that is larger than said table, each of said extension units being selectively positioned in a stored position;
a plurality of panels, each of said panels being selectively positioned on said table to define a horizontal support surface;
wherein said table has a pair of outward members, a pair of medial members and a plurality of topmost members; and
wherein said plurality of extension units includes a first extension unit, a second extension unit and a pair of third extension units, each of said plurality of extension units comprising a pair of first bars, each of said first bars having a first end, each of first bars corresponding to said first extension unit being slidably positioned in an associated one of said outward members having said first bars extending laterally away from said table, each of said first bars corresponding to said second extension unit being slidably positioned in an associated one of said medial members having said first bars extending laterally away from said table, said first extension unit being positioned on a opposite side of said table with respect to said second extension unit, each of said first bars corresponding to said pair of third extension units being slidably positioned in an associated one of said topmost members, said third extension units being positioned on opposite sides of said table with respect to each other.

7. The assembly according to claim 6, further comprising a second bar being coupled between said pair of first bars, said second bar being aligned with said first end of said first bars, said second bar corresponding to each of said extension units being spaced from said table when said extension units is positioned in said deployed position wherein said second bar is configured to support the object, said second bar corresponding to each of said extension units abutting said table when said extension units are positioned in said stored position, said second bar having an outwardly facing surface with respect to said table.

8. The assembly according to claim 7, further comprising a plate being coupled to said outwardly facing surface corresponding to each of said first and second extension units, said plate extending downwardly from said outwardly facing surface wherein each of said plates is configured to have a support leg selectively coupled thereto to support said first and second extension units.

9. The assembly according to claim 2, wherein each of said panels has a first surface, said first surface lying on said members corresponding to said top side when said panels are positioned on said table.

10. The assembly according to claim 9, wherein said first surface of each of said panels has a tab extending downwardly therefrom, said tab on each of said panels engaging an associated one of said members corresponding to said top side to inhibit said panels from sliding off of said table.

11. A work table assembly having a plurality of extendable supports wherein said assembly is configured to support an object for cutting, said assembly comprising:
a table being configured to be positioned on a support surface, said table being configured to have an object positioned thereon for cutting, said table having a top side and a perimeter side extending downwardly therefrom, each of said top side and said perimeter side comprising a plurality of intersecting members to define a grid, said members corresponding to said top side including a pair of outward members and a pair of medial members, each of said outward and medial members being substantially hollow and having a pair of open ends, said perimeter side having a first side and a second side, said members corresponding to each of said first and second side including a pair of topmost members, each of said topmost members being substantially hollow and having a pair of open ends, said perimeter side having a plurality of legs extending downwardly therefrom wherein each of said legs is configured to abut the support surface, said members corresponding to said top side including a guide member, said guide member being spaced from an associated one of said outward members to define a cutting space between said guide member and said outward member wherein said cutting spaced is configured to receive a blade of the saw thereby facilitating the saw to be urged along an entire length of said table without engaging said table;
a plurality of extension units, each of said extension units being slidably coupled to said table, each of said extension units being selectively positioned in a deployed position wherein each of said extension units is configured to support an object that is larger than said table, each of said extension units being selectively positioned in a stored position, said plurality of extension units including a first extension unit, a second extension unit and a pair of third extension units, each of said plurality of extension units comprising:
a pair of first bars, each of said first bars having a first end, each of first bars corresponding to said first extension unit being slidably positioned in an associated one of said outward members having said first bars extending laterally away from said table, each of said first bars corresponding to said second extension unit being slidably positioned in an associated one of said medial members having said first bars extending laterally away from said table, said first extension unit being positioned on a opposite side of said table with respect to said second extension unit, each of said first bars corresponding to said pair of third extension units being slidably positioned in an associated one of said topmost members, said third extension units being positioned on opposite sides of said table with respect to each other,
a second bar being coupled between said pair of first bars, said second bar being aligned with said first end of said first bars, said second bar corresponding to each of said extension units being spaced from said table when said extension units is positioned in said deployed position wherein said second bar is configured to support the object, said second bar corresponding to each of said extension units abutting said table when said extension units are positioned in said stored position, said second bar having an outwardly facing surface with respect to said table, and
a plate being coupled to said outwardly facing surface corresponding to each of said first and second extension units, said plate extending downwardly from said outwardly facing surface wherein each of said plates is configured to have a support leg selectively coupled thereto to support said first and second extension units; and
a plurality of panels, each of said panels being selectively positioned on said table to define a horizontal support surface, each of said panels having a first surface, said first surface lying on said members corresponding to said top side when said panels are positioned on said table, said first surface of each of said panels having a tab extending downwardly therefrom, said tab on each of said panels engaging an associated one of said members corresponding to said top side to inhibit said panels from sliding off of said table.
